(19) United States
(12) Patent Application Publication
(10) Pub. No.: US 2022/0340718 A1
(43) Pub. Date: Oct. 27, 2022

(54) LIGNIN DEGRADATION PRODUCT-BISPHENOL A-POLYURETHANE POLYCONDENSATE ADDITIVE AND PREPARATION METHOD THEREOF

(71) Applicant: FUZHOU UNIVERSITY, Fuzhou (CN)

(72) Inventors: Minghua Liu, Fuzhou (CN); Xiuhua Lin, Fuzhou (CN); Lihui Chen, Fuzhou (CN); Yaohua Liu, Fuzhou (CN); Weilin Wang, Fuzhou (CN)

(73) Assignee: FUZHOU UNIVERSITY, Quanzhou (CN)

(21) Appl. No.: 17/717,041

(22) Filed: Apr. 9, 2022

(30) Foreign Application Priority Data
Apr. 23, 2021 (CN) 202110444359.8

(51) Int. Cl. C08G 81/00; C08H 7/00

(52) U.S. Cl. CPC C08G 81/00; C08H 6/00

(57) ABSTRACT

The invention discloses a lignin degradation product-bisphenol A-polyurethane polycondensate additive, and a preparation method thereof. Lignin is used as a raw material, and is degraded by an alkali activator, a metal catalyst and nitrobenzene to obtain the lignin degradation product; then, the obtained lignin degradation product is uniformly mixed with bisphenol A, and polyurethane is added; finally, the additive is obtained after heating reaction and drying. The preparation process of the invention is simple, and the obtained lignin degradation product has a small and stable molecular weight and has abundant phenolic hydroxyl and alcoholic hydroxyl sites, which can improve the dispersibility of the product, with strong cohesiveness and good waterproofness. It solves the problem of industrial application that lignin replaces part of phenols in the prior art, which leads to the decline of product performance, improves the total substitution rate of chemicals derived from biomass to bisphenol A derived from fossil resources, and significantly reducing the discharge of phenolic compounds. The additive is an environment-friendly polymeric material with excellent development potential.

### BACKGROUND OF THE INVENTION

### 1. Technical Field

The invention belongs to the fields of fine chemicals and environment-friendly materials, and particularly relates to a preparation method and application of a lignin degradation product-bisphenol A-polyurethane polycondensate additive.

### 2. Description of Related Art

With the development of modern industry and the improvement of people's living standards, the demand for fossil energy is increasingly expanding. However, the expansion of mining has caused a fossil energy shortages and an increasingly heavy environmental pressure. Therefore, it is of great practical significance and long-term strategic significance to develop and utilize renewable biomass resources to replace fossil resources.

Lignin is a kind of natural organic polymer that forms the plant skeleton. Lignin, with an enormous amount, is cheap, easily available, environment-friendly and renewable, and it is the only non-petroleum resource that can provide aryl compounds. Every year, about 50 million tons of industrial lignin are produced by the pulping and papermaking industry globally, but at present, about 90% of industrial lignin is simply treated as waste, such as burning to obtain low-grade heat or subjected to chemical recovery, which not only wastes resources, but also causes serious pollution to the surrounding environment. In view of the pressure of the environment and the promulgation of relevant laws, the recovery and recycling of industrial lignin have attracted more and more attention from researchers.

Because lignin has a complex three-dimensional spatial network structure and low reactivity, it cannot be directly utilized and degraded in nature. However, lignin has good dispersibility and contains a variety of functional groups. Degrading lignin to obtain small lignin molecules with molecular weights ranging from several hundred to several thousand can improve its thermal stability and has high utilization value. At present, lignin is degraded by weakening or breaking chemical bonds in lignin, or producing some highly reactive groups or active sites, so as to increase the reactivity of lignin. In this way, the weight-average molecular weight and steric hindrance of reaction of lignin are reduced to achieve the purpose of degradation. The patent CN103360192A provides a method for preparing monoaromatic compound through carrying out microwave synergistic catalyzed oxidative degradation on alkali lignin. In this method, alkali lignin, CuO, Fe₂(SO₄) and oxidizing agent are mixed for reaction in a microwave reaction tank, and the monoaromatic compounds are obtained through degradation under a microwave power of 300-600 W and a reaction temperature of 160-190° C. However, the method has the defects of high side reaction proneness, poor selectivity of degradation products and low product yield. The patent CN106946660A provides a method for preparing monophenol compound through catalyzing degradation of lignin by using ammino-complex. Metal salt and ammonia water are used to form a stable ammino-complex solution under alkaline conditions, and oxidative degradation is realized in the presence of peroxide. However, the overall reaction time is long, and high pressure conditions are needed. The patent CN107098803A provides a method for separating, purifying and degrading lignin, using tandem catalyst (such as solid heteropolyacid salt-Raney nickel) to efficiently catalyze the degradation of extracted lignin to obtain aromatic platform compounds. However, this method is too complicated and the reaction time is long. Due to the high complexity of the structure of lignin, the yield of monophenol compounds reported in most literatures on lignin degradation is low, so it is necessary to develop a new method to improve the degradation efficiency of lignin and realize the directional depolymerization of lignin, so as to solve the problems and defects existing in the prior art and realize the industrial application of lignin as a recyclable resource.

The lignin degradation products obtained by degradation are rich in phenolic hydroxyl groups, methoxyl groups, ester groups and other active functional groups, and the number of phenolic hydroxyl groups as the main active functional group is greatly increased compared with original lignin. The degradation product is not only an important chemical itself, but may also be further prepared into a fine chemical intermediate. With going deep into the research, the high-value utilization of lignin degradation products is realized in some industries, but many reaction processes are still under exploration, and the industrial utilization rate of lignin is still low, which is undoubtedly a great waste. Through physical and chemical modification of lignin degradation products, the structures and properties of lignin degradation products are further optimized, and different functions are realized, so that they can be applied to dye, ceramics, concrete and other fields.

In the invention, lignin is first subjected to catalytic oxidation degradation to obtain polymers with molecular weights below 1,000, so as to facilitate subsequent molecular reforming and chemical modification, and then polycondensation reaction is carried out. Through molecular weight adjustment, an additive with low dosage, high dispersibility and a wide application range is developed, which may be used as a binder, a ceramic additive, dye dispersant, concrete water reducing agent and coal water slurry dispersant, etc., so as to meet the requirements of developing renewable resources, promoting circular economy and pursuing sustainable development. Broader utilization of lignin is of great significance to the development of society, economy and environment.

### BRIEF SUMMARY OF THE INVENTION

The purpose of the invention is to overcome the shortcomings of the prior art by providing a lignin degradation product-bisphenol A-polyurethane polycondensate additive, and a preparation method thereof. The preparation process of the additive is simple, cheap, environment-friendly and suitable for industrial production.

In order to achieve the above purpose, the invention adopts the following technical solution:

A preparation method of a lignin degradation product-bisphenol A-polyurethane polycondensate additive, including the steps of:

(1) The lignin, alkali activator, metal catalyst and water were stirred evenly, nitrobenzene was added and reacted for 2-6 h at 200-300° C. Then, the reaction liquid was cooled to 40-60° C., and the lignin degradation products were obtained after removing solid residues.

(2) Bisphenol A is added to the lignin degradation product obtained in step (1) and stirred evenly. Then, polyurethane is added, among the temperature of 70-100° C. for a reaction for 2.0-5.0 h, cooling down and discharging after the reaction to get brown liquid, and thus to obtain the lignin degradation product-bisphenol A-polyurethane polycondensate additive after drying.

Raw materials include, by mass, 15.0%-30% of lignin, 5.0%-10.5% of alkali activator, 1.0%-3.0% of metal catalyst, 6.5%-12.0% of nitrobenzene, 2.0%-10.0% of bisphenol A, 5.0%-15.0% of polyurethane, and 43.0%-70.0% of water, 100% in total.

Preferably, the lignin comprises any one or more of organosolv lignin, enzymatic hydrolyzed lignin, milled-wood lignin, sulphate lignin, sulfonate lignin, alkali lignin and natural lignin.

Preferably, the alkali activator comprises any one or more of KOH, NaOH, Mg(OH)₂, LiOH and Ca(OH)₂.

Preferably, the metal catalyst comprises any one or more of NiCl₂, CoCl₂, MoCl₂, LaMnO₃ and LaCoO₃.

For a lignin degradation product-bisphenol A-polyurethane polycondensate additive prepared by the above method, the insoluble matter content is less than or equal to 0.5%, and the relative molecular mass Mn may be 8000-20000, 6000-15000, 20000-30000, 25000-40000 and 30000-50000. The additive may be used as ceramic additive, dye dispersant, concrete water reducing agent, coal water slurry dispersant and binder.

Preferably, the additive may be directly used in a powdery state or prepared into an aqueous solution for use.

Compared with the prior art, the invention has the following advantages and beneficial effects:

(1) In the invention, the alkali activator, metal catalyst and nitrobenzene are used to oxidize and degrade lignin, and intermediate products generated in the degradation process produce insoluble oligomers easily through condensation reaction, which may increase contact sites between the metal catalyst and lignin molecules, thereby improving the reaction efficiency and realizing directional selection, that is, breaking ether bonds of the lignin molecules to generate new hydroxyl groups, so as to improve the hydroxyl content in degraded lignin, promote the uniformization of the relative molecular mass of degradation products and generate more active groups, which is beneficial to further modification and increases the utilization value.

(2) In the invention, the lignin degradation product, bisphenol A and polyurethane are used to prepare the additive, thus avoiding the waste of industrial lignin. The addition of bisphenol A enables free radicals generated by lignin degradation to be captured, prevents the combination of the free radicals, and achieves polymerization inhibition, so that phenolic hydroxyl sites and alcoholic hydroxyl sites of the degradation product can be used to form a network structure, which facilitates dispersion and adhesion. Besides, the content of free bisphenol A in the reaction system is reduced, thus solving the industrial application problem of product performance degradation caused by the substitution of lignin for some phenols in the prior art. The total substitution rate of biomass chemicals for fossil resource bisphenol A was increased, and the emissions of phenolic compounds were significantly reduced, providing a new way of comprehensive utilization of lignin. In addition, in subsequent reaction, hydroxyl groups may react with polyurethane, which may effectively improve the crosslinking degree of the additive, so that the prepared additive has a high water reduction rate, good dispersibility and cohesiveness, and can improve the bonding strength and flexural strength of slurry. It can be widely used in the fields of binders, ceramic additives, dye dispersants, concrete water reduction agents, coal water slurry dispersants and the like.

(3) The invention has the advantages of simple preparation technology, low synthesis conditions, easily controlled production conditions, wide raw material sources and relatively low price, which can effectively reduce energy consumption and save costs, and has important socio-economic and environmental significance.

### DETAILED DESCRIPTION OF THE INVENTION

In order to make the content of the invention easier to understand, the technical solution of the invention will be further explained below with reference to specific embodiments, but the invention is not limited to this.

### Embodiment 1

251.0 kg of Eucommia lignin, 107.6 kg of potassium hydroxide, 35.9 kg of NiCl₂ and 850.2 kg of water were evenly mixed by stirring, and 143.4 kg of nitrobenzene was added for a reaction for 3.4 hours at 250° C.; after a reaction solution was cooled to 48° C., lignin degradation product was obtained after removing solid residues; and 89.6 kg of bisphenol A was added to the lignin degradation product, the mixture was stirred evenly, then 179.3 kg of polyurethane was added, the temperature was increased to 95° C. for a reaction for 2.0 hours. After the reaction completed, the temperature was lowered and the material was removed to obtain brown liquid, and the brown liquid was dried to obtain a ceramic additive with a relative molecular mass Mₙ of 12500.

### Embodiment 2

251.0 kg of bamboo lignin, 107.6 kg of magnesium hydroxide, 23.9 kg of CoCl₂ and 537.8 kg of water were evenly mixed by stirring, and 83.7 kg of nitrobenzene was added for a reaction for 2.5 hours at 300′C; after a reaction solution was cooled to 45′C, a lignin degradation product was obtained after removing solid residues; and 71.7 kg of bisphenol A was added to the lignin degradation product, the mixture was stirred evenly, then 143.4 kg of polyurethane was added, the temperature was increased to 95′C for a reaction for 3.0 hours. After the reaction completed, the temperature was lowered and the material was removed to obtain brown liquid, and the brown liquid was dried to obtain a dye dispersant with a relative molecular mass Mₙ of 28500.

### Embodiment 3

143.4 kg of palm lignin and 100 kg of corncob lignin, 108.2 kg of sodium hydroxide, 13.5 kg of LaCoO₃ and 689.5 kg of water were evenly mixed by stirring, and 108.2 kg of nitrobenzene was added for a reaction for 4.5 hours at 266° C.; after a reaction solution was cooled to 50° C., a lignin degradation product was obtained after removing solid residues; and 67.6 kg of bisphenol A was added to the lignin degradation product, the mixture was stirred evenly, then 121.9 kg of polyurethane was added, the temperature was increased to 100° C. for a reaction for 2.8 hours. After the reaction completed, the temperature was lowered and the material was removed to obtain brown liquid, and the brown liquid was dried to obtain a binder with a relative molecular mass Mₙ of 41200.

### Embodiment 4

390.7 kg of Chinese ash lignin, 125.0 kg of magnesium hydroxide, 31.3 kg of LaMnO₃ and 687.6 kg of water were evenly mixed by stirring, and 140.7 kg of nitrobenzene was added for a reaction for 5.0 hours at 220′C; after a reaction solution was cooled to 50° C., lignin degradation product was obtained after removing solid residues; and 62.5 kg of bisphenol A was added to the lignin degradation product, the mixture was stirred evenly, then 125.0 kg of polyurethane was added, the temperature was increased to 88′C for a reaction for 3.0 hours, After the reaction completed, the temperature was lowered and the material was removed to obtain brown liquid, and the brown liquid was dried to obtain a ceramic additive with a relative molecular mass Mₙ of 15200.

### Embodiment 5

302.5 kg of Eucommia lignin, 37.8 kg of magnesium hydroxide and 67.4 kg of sodium hydroxide, 39.5 kg of NiCl₂ and 631.2 kg of water were evenly mixed by stirring, and 92.1 kg of nitrobenzene was added for a reaction for 5.5 hours at 185′C; after a reaction solution was cooled to 50′C, 1 lignin degradation product was obtained after removing solid residues; and 52.6 kg of bisphenol A was added to the lignin degradation product, the mixture was stirred evenly, then 92.1 kg of formaldehyde was added, the temperature was increased to 80° C. for a reaction for 2.5 hours. After the reaction completed, the temperature was lowered and the material was removed to obtain brown liquid, and the brown liquid was dried to obtain a coal water slurry additive with a relative molecular mass Mₙ of 28620.

### Embodiment 6

221.0 kg of corncob lignin, 49.1 kg of sodium hydroxide, 16.4 kg of LaMnO₃ and 368.3 kg of water were evenly mixed by stirring, and 65.5 kg of nitrobenzene was added for a reaction for 4.0 hours at 260° C.; after a reaction solution was cooled to 55° C., a lignin degradation product was obtained after removing solid residues; and 32.7 kg of bisphenol A was added to the lignin degradation product, the mixture was stirred evenly, then 65.5 kg of polyurethane was added, the temperature was increased to 95′C for a reaction for 2.0 hours. After the reaction completed, the temperature was lowered and the material was removed to obtain brown liquid, and the brown liquid was dried to obtain a concrete water reducing agent with a relative molecular mass Mₙ of 13800.

### Embodiment 7

238.5 kg of bamboo lignin, 95.4 kg of potassium hydroxide, 35.8 kg of MoCl₂ and 620.1 kg of water were evenly mixed by stirring, and 83.5 kg of nitrobenzene was added for a reaction for 3.0 hours at 285′C; after a reaction solution was cooled to 60° C., lignin degradation product was obtained after removing solid residues; and 47.7 kg of bisphenol A was added to the lignin degradation product, the mixture was stirred evenly, then 71.6 kg of polyurethane was added, the temperature was increased to 88′C for a reaction for 2.4 hours. After the reaction completed, the temperature was lowered and the material was removed to obtain brown liquid, and the brown liquid was dried to obtain a dye dispersant with a relative molecular mass Mₙ of 28800.

### Embodiment 8

201.8 kg of corncob lignin, 57.7 kg of sodium hydroxide, 7.2 kg of MoCl₂ and 324.1 kg of water were evenly mixed by stirring, and 50.4 kg of nitrobenzene was added for a reaction for 5.2 hours at 255° C.; after a reaction solution was cooled to 55′C, a lignin degradation product was obtained after removing solid residues; and 28.8 kg of bisphenol A was added to the lignin degradation product, the mixture was stirred evenly, then 50.4 kg of polyurethane was added, the temperature was increased to 90° C. for a reaction for 3.0 hours. After the reaction completed, the temperature was lowered and the material was removed to obtain brown liquid, and the brown liquid was dried to obtain a concrete water reducing agent with a relative molecular mass Mₙ of 8790.

### Embodiment 9

78.4 kg of Eucommia lignin, 133.6 kg of bamboo lignin, 74.2 kg of sodium hydroxide, 21.2 kg of CoCl₂ and 519.4 kg of water were evenly mixed by stirring, and 106.0 kg of nitrobenzene was added for a reaction for 5.0 hours at 280° C.; after a reaction solution was cooled to 50° C., lignin degradation product was obtained after removing solid residues; and 31.8 kg of bisphenol A was added to the lignin degradation product, the mixture was stirred evenly, then 95.4 kg of polyurethane was added, the temperature was increased to 95′C for a reaction for 2.5 hours. After the reaction completed, the temperature was lowered and the material was removed to obtain brown liquid, and the brown liquid was dried to obtain a binder with a relative molecular mass Mₙ of 48520.

### Embodiment 10

246.7 kg of Eucommia lignin, 67.3 kg of sodium hydroxide, 11.2 kg of NiCl₂ and 504.6 kg of water were evenly mixed by stirring, and 112.1 kg of nitrobenzene was added for a reaction for 4.0 hours at 280° C.; after a reaction solution was cooled to 521, lignin degradation product was obtained after removing solid residues; and 56.1 kg of bisphenol A was added to the lignin degradation product, the mixture was stirred evenly, then 123.4 kg of polyurethane was added, the temperature was increased to 98′C for a reaction for 3.5 hours. After the reaction completed, the temperature was lowered and the material was removed to obtain brown liquid, and the brown liquid was dried to obtain a coal water slurry additive with a relative molecular mass Mₙ of 32500.

Performance Test:

1. Binder

By referring to GB/T14732-2017, the performance of the products obtained in the embodiments and similar products was tested. The test results are shown in Table 1.

TABLE 1
Properties of binder

| | | Free | | Impact |
|---|---|---|---|---|
| | | bisphenol | Bending | tough- |
| | Dosage | A content | strength | ness |
| Products | (wt %) | (wt %) | (MPa) | (kl/m²) |
| Embodiment 1 | 0.3 | 1.42 | 252 | 33 |
| Embodiment 2 | 0.3 | 1.55 | 243 | 27 |
| Embodiment 3 | 0.3 | 0.95 | 319 | 44 |
| Embodiment 4 | 0.3 | 1.23 | 275 | 31 |
| Embodiment 5 | 0.3 | 1.24 | 295 | 35 |
| Embodiment 6 | 0.3 | 1.33 | 288 | 36 |
| Embodiment 7 | 0.3 | 1.15 | 267 | 38 |
| Embodiment 8 | 0.3 | 1.18 | 300 | 38 |
| Embodiment 9 | 0.3 | 0.97 | 322 | 48 |
| Embodiment 10 | 0.3 | 1.23 | 281 | 40 |

As can be seen from Table 1, compared with other products, the products obtained in Embodiments 3 and 9 have fewer free bisphenol A compounds, higher bending strength and stronger impact toughness, thus being suitable for serving as binders.

2. Ceramic Additive

The composition (wt %) of ceramic slurry is shown in Table 2. The products obtained in the embodiments and other similar products were added to ceramic slurry for comparison in terms of fluidity, viscosity and green strength. The results are shown in Table 3. The green flexural strength test was conducted by referring to GBT3810.4□2006 Part 4: Determination of rupture modulus and breaking strength.

TABLE 2
Composition of ceramic slurry (wt %)

| | | | Calcium- | | |
|---|---|---|---|---|---|
| | | Black | enriched | Porcelain | |
| Pyrophyllite | Clay | talc | rice | clay | Diopside |
| 21 | 25 | 10 | 14 | 18 | 12 |

TABLE 3
Comparison of products in fluidity,
viscosity and green strength

| | | | | | Green |
|---|---|---|---|---|---|
| | Dosage | Specific | Outflow | Viscosity | strength |
| Products | (wt %) | weight | time (s) | (MPa · s) | (MPa) |
| Sodium | 0.3 | 1.7020 | 37 | 176 | 1.52 |
| tripoly- | | | | | |
| phosphate | | | | | |
| Sodium | 0.3 | 1.7015 | 43 | 190 | 1.48 |
| silicate | | | | | |
| Water glass | 0.3 | 1.7054 | 40 | 186 | 1.48 |
| Embodiment 1 | 0.3 | 1.7098 | 36 | 186 | 2.33 |
| Embodiment 2 | 0.3 | 1.7001 | 38 | 190 | 2.05 |
| Embodiment 3 | 0.3 | 1.7044 | 44 | 205 | 1.88 |
| Embodiment 4 | 0.3 | 1.7057 | 33 | 175 | 2.30 |
| Embodiment 5 | 0.3 | 1.7069 | 39 | 178 | 2.05 |
| Embodiment 6 | 0.3 | 1.7077 | 40 | 178 | 2.12 |
| Embodiment 7 | 0.3 | 1.7023 | 42 | 200 | 1.88 |
| Embodiment 8 | 0.3 | 1.7034 | 45 | 209 | 2.04 |
| Embodiment 9 | 0.3 | 1.7002 | 41 | 198 | 2.08 |
| Embodiment 10 | 0.3 | 1.7095 | 38 | 191 | 2.13 |

As can be seen from Table 3, compared with other products, the products obtained in Embodiments 1 and 4 have shorter outflow time and higher strength, thus being suitable for serving as ceramic additives.

3. Dye Dispersant

The thermal stability of the products obtained in the embodiments to vat dyes was tested and rated according to HG/T 3507□2008 “Sodium lignin sulphonate dispersing agent” and HG/t 3399□2001 “Determination of dye diffusion performance”. The test results are shown in Table 4.

TABLE 4
Comparison of products in thermal stability

| | Thermal stability (tested with olive T dye) | | | |
|---|---|---|---|---|
| Products | 80° C. | 100° C. | 130° C. | 150° C. |
| Embodiment 1 | Grade 5 | Grade 4 | Grade 3 | Grade 3 |
| Embodiment 2 | Grade 5 | Grade 5 | Grade 5 | Grade 5 |
| Embodiment 3 | Grade 5 | Grade 5 | Grade 4 | Grade 3 |
| Embodiment 4 | Grade 5 | Grade 5 | Grade 4 | Grade 4 |
| Embodiment 5 | Grade 5 | Grade 5 | Grade 4 | Grade 3 |
| Embodiment 6 | Grade 5 | Grade 4 | Grade 4 | Grade 4 |
| Embodiment 7 | Grade 5 | Grade 5 | Grade 5 | Grade 5 |
| Embodiment 8 | Grade 5 | Grade 5 | Grade 4 | Grade 3 |
| Embodiment 9 | Grade 5 | Grade 4 | Grade 4 | Grade 3 |
| Embodiment 10 | Grade 4 | Grade 4 | Grade 3 | Grade 3 |

As can be seen from Table 4, compared with other products, the products obtained in Embodiments 2 and 7 have better thermal stability, thus being suitable for serving as dye dispersants.

4. Coal Water Slurry Dispersant

The products obtained in the embodiments and similar products were tested for the dispersibility and stability of coal water slurry. Heishan coal was selected as the research object. After crushing, grinding, screening and grading, a certain amount of water and dispersant products (dosage of 0.3 wt %) were added and stirred evenly to obtain coal water slurry with different concentrations. The test results are shown in Table 5.

TABLE 5
Comparison of products of the invention
in dispersibility and stability

| | Slurry | | | |
|---|---|---|---|---|
| | concentration | Viscosity | | 7-day |
| Products | (%) | (MPa · s) | Fluidity | stability |
| Embodiment 1 | 64.8 | 1450 | B | Grade 1 |
| Embodiment 2 | 63.9 | 1380 | A | Grade 2 |
| Embodiment 3 | 64.7 | 1440 | A | Grade 1 |
| Embodiment 4 | 65.5 | 1580 | B | Grade 2 |
| Embodiment 5 | 68.8 | 1860 | A | Grade 1 |
| Embodiment 6 | 63.5 | 1350 | B | Grade 1 |
| Embodiment 7 | 64.8 | 1500 | A | Grade 1 |
| Embodiment 8 | 66.7 | 1680 | B | Grade 2 |
| Embodiment 9 | 67.0 | 1700 | B | Grade 2 |
| Embodiment 10 | 68.5 | 1840 | A | Grade 1 |

As can be seen from Table 5, compared with other products, the products obtained in Embodiments 5 and 10 have higher slurry concentration and higher viscosity, thus being suitable for serving as coal water slurry dispersants.

5. Concrete Water Reducing Agent

By referring to GB/T2794□1995, the performance of the products obtained in the embodiments and similar products was tested. The test results are shown in Table 6.

TABLE 6
Comparison of products in strength and fluidity

| | | | 7-day | 28-day | |
|---|---|---|---|---|---|
| | | | com- | com- | |
| | | | pressive | pressive | |
| | | Cement | strength | strength | |
| | Dosage | paste | ratio | ratio | Rusting of |
| Products | (wt %) | fluidity | (%) | (%) | steel bars |
| Industrial | 0.3 | 180 | 125 | 117 | Passivation |
| sodium | | | | | |
| sulfonate | | | | | |
| Embodiment 1 | 0.3 | 178 | 130 | 124 | Passivation |
| Embodiment 2 | 0.3 | 175 | 135 | 130 | Passivation |
| Embodiment 3 | 0.3 | 180 | 132 | 126 | Passivation |
| Embodiment 4 | 0.3 | 177 | 124 | 120 | Passivation |
| Embodiment 5 | 0.3 | 181 | 126 | 121 | Passivation |
| Embodiment 6 | 0.3 | 173 | 137 | 134 | Passivation |
| Embodiment 7 | 0.3 | 179 | 127 | 122 | Passivation |
| Embodiment 8 | 0.3 | 172 | 135 | 133 | Passivation |
| Embodiment 9 | 0.3 | 176 | 127 | 122 | Passivation |
| Embodiment | 0.3 | 183 | 125 | 120 | Passivation |
| 10 | | | | | |

As can seen from Table 6, compared with other products, the products obtained in Embodiments 6 and 8 have lower cement paste fluidity, higher compressive strength ratios and smaller changes after being left to stand, thus being suitable for serving as concrete water reducing agents.

The above embodiments are only preferred ones of the invention, and all equivalent changes and modifications made according to the scope of the patent application of the invention should be within the scope of the invention.

What is claimed is:

1. A preparation method of a lignin degradation product-bisphenol A-polyurethane polycondensate additive, comprising the following steps:
(1) The lignin, alkali activator, metal catalyst and water were stirred evenly, nitrobenzene was added and reacted for 2-6 h at 200-300° C. Then, the reaction liquid was cooled to 40-60° C., and the lignin degradation products were obtained after removing the solid residues.
(2) Bisphenol A is added to the lignin degradation product obtained in step (1) and stirred evenly. Then, polyurethane is added, at the temperature of 70-100° C. for a reaction for 2.0-5.0 h, cooling down and discharging after the reaction obtaining brown liquid, and thus to obtain the lignin degradation product-bisphenol A-polyurethane polycondensate additive after drying.

2. The preparation method of the lignin degradation product-bisphenol A-polyurethane polycondensate additive according to claim 1, wherein raw materials include, by mass, 15.0%-30% of lignin, 5.0%-10.5% of alkali activator, 1.0%-3.0% of metal catalyst, 6.5%-12.0% of nitrobenzene, 2.0%-10.0% of bisphenol A, 5.0/0-15.00% of polyurethane, and 43.0%-70.0% of water, 100% in total.

3. The preparation method of the lignin degradation product-bisphenol A-polyurethane polycondensate additive according to claim 1, wherein the lignin comprises any one or more of organosolv lignin, enzymatic hydrolyzed lignin, milled-wood lignin, sulphate lignin, sulfonate lignin, alkali lignin and natural lignin.

4. The preparation method of the lignin degradation product-bisphenol A-polyurethane polycondensate additive according to claim 3, wherein raw materials include, by mass, 15.0%-30% of lignin, 5.0%-10.5% of alkali activator, 1.0%/9-3.0% of metal catalyst, 6.5%-12.0% of nitrobenzene, 2.0%-10.0% of bisphenol A, 5.0%-15.0% of polyurethane, and 43.0%-70.0% of water, 100% in total.

5. The preparation method of the lignin degradation product-bisphenol A-polyurethane polycondensate additive according to claim 1, wherein the alkali activator comprises any one or more of KOH, NaOH, Mg(OH)₂, LiOH and Ca(OH)₂.

6. The preparation method of the lignin degradation product-bisphenol A-polyurethane polycondensate additive according to claim 5, wherein raw materials include, by mass, 15.0%-30% of lignin, 5.0%-10.5% of alkali activator, 1.0%-3.0% of metal catalyst, 6.5%-12.0% of nitrobenzene, 2.0%-10.0% of bisphenol A, 5.0%-15.0% of polyurethane, and 43.0%-70.0% of water, 100% in total.

7. The preparation method of the lignin degradation product-bisphenol A-polyurethane polycondensate additive according to claim 1, wherein the metal catalyst comprises any one or more of NiCl₂, CoCl₂, MoCl₂, LaMnO₃ and LaCoO₃.

8. The preparation method of the lignin degradation product-bisphenol A-polyurethane polycondensate additive according to claim 7, wherein raw materials include, by mass, 15.0%-30% of lignin, 5.0%-10.5% of alkali activator, 1.0%-3.0% of metal catalyst, 6.5%-12.0% of nitrobenzene, 2.0%-10.0% of bisphenol A, 5.0%-15.0% of polyurethane, and 43.0%-70.0% of water, 100% in total.

9. A lignin degradation product-bisphenol A-polyurethane polycondensate additive prepared by the method according to claim 1, wherein an insoluble matter content of the additive is less than or equal to 0.5%, and a relative molecular mass Mn is 8000-50000.

10. A lignin degradation product-bisphenol A-polyurethane polycondensate additive prepared by the method according to claim 9, wherein raw materials include, by mass, 15.0%-30% of lignin, 5.0%-10.5% of alkali activator, 1.0%-3.0% of metal catalyst, 6.5%-12.0% of nitrobenzene, 2.0%-10.0% of bisphenol A, 5.0%-15.0% of polyurethane, and 43.0%-70.0% of water, 100% in total.

11. A lignin degradation product-bisphenol A-polyurethane polycondensate additive prepared by the method according to claim 9, wherein the lignin comprises any one or more of organosolv lignin, enzymatic hydrolyzed lignin, milled-wood lignin, sulphate lignin, sulfonate lignin, alkali lignin and natural lignin.

12. A lignin degradation product-bisphenol A-polyurethane polycondensate additive prepared by the method according to claim 9, wherein the alkali activator comprises any one or more of KOH, NaOH, Mg(OH)₂, LiOH and Ca(OH)₂.

13. A lignin degradation product-bisphenol A-polyurethane polycondensates additive prepared by the method according to claim 9, wherein the metal catalyst comprises anyone or more of NiCl₂, CoCl₂, MoCl₂, LaMnO₃ and LaCoO₃.
